(19) United States
(12) Patent Application Publication
(10) Pub. No.: US 2019/0357724 A1
(43) Pub. Date: Nov. 28, 2019

(54) Heated Beverage Container System

(71) Applicant: Lauren L. Krol, Holmdel, NJ (US)

(72) Inventor: Lauren L. Krol, Holmdel, NJ (US)

(21) Appl. No.: 16/419,599

(22) Filed: May 22, 2019

Related U.S. Application Data
(60) Provisional application No. 62/675,241, filed on May 23, 2018.

(51) Int. Cl. A47J 36/24

(52) U.S. Cl. CPC A47J 36/2466; A47J 2202/00

(57) ABSTRACT

A heated beverage container system. The system includes a container having a base having an annular sidewall extending therefrom and defining an interior volume, wherein the annular sidewall terminates at an open upper end. A heating element is disposed within a housing, wherein the housing is removably securable to the base such that heat generated by the heating element is transferred into the interior volume. A first power source is disposed within the housing and is operably connected to the heating element, and an outlet is disposed on the housing, wherein the outlet can operably connect the heating element to a second power source. An activation control is disposed on the housing to selectively toggle the heating element between an activated state and a deactivated state.

### CROSS REFERENCE TO RELATED APPLICATIONS

This application claims the benefit of U.S. Provisional Application No. 62/675,241 filed on May 23, 2018. The above identified patent application is herein incorporated by reference in its entirety to provide continuity of disclosure.

### BACKGROUND OF THE INVENTION

The present invention relates to heated beverage container systems. More particularly, the present invention pertains to heated beverage container systems having two independent power sources operably connected to a heating element removably securable to a base of a beverage container.

Many people enjoy heated beverages, such as coffee, tea, and hot chocolate, however it can be difficult to maintain a desired temperature of the heated beverage over a long period of time. Typically, once a beverage has cooled, a consumer will attempt to reheat the beverage, as consuming a cooled heated beverage is less enjoyable. Reheating a beverage is often cumbersome, requiring additional tools, such as a microwave, hot plate, or the like, which may not be readily available in all situations. Additionally, these heating methods can lead to overheating beyond a desired temperature or spillage of the beverage, which both lead to time consuming remedies, such as waiting for the beverage to cool to the desired temperature or cleaning the spill. Therefore, a device that readily allows a user to heat and maintain a beverage at a desired temperature over a long period of time is desired.

In light of the devices disclosed in the known art, it is submitted that the present invention substantially diverges in design elements from the known art and consequently it is clear that there is a need in the art for an improvement to existing heated beverage container systems. In this regard, the instant invention substantially fulfills these needs.

### SUMMARY OF THE INVENTION

In view of the foregoing disadvantages inherent in the known types of heated beverage container systems now present in the known art, the present invention provides a heated beverage container system wherein the same can be utilized for providing convenience for the user when heating a beverage to a desired temperature or maintaining the desired temperature of a heated beverage.

The present system comprises a container comprising a base having an annular sidewall extending therefrom defining an interior volume, wherein the annular sidewall terminates at an open upper end. A heating element is disposed within a housing, wherein the housing is configured to removably secure to the base such that heat generated by the heating element is transferred into the interior volume. A first power source is disposed within the housing and operably connected to the heating element. An outlet is disposed on the housing, wherein the outlet is configured to operably connect the heating element to a second power source, wherein the first power source and the second power source are independent. An activation control is disposed on the housing, wherein the activation control selectively toggles the heating element between an activated state and a deactivated state. In some embodiments, an exterior surface of the container and an outer surface of the housing are aligned when the housing is secured to the base. In another embodiment, the base comprises an internally threaded recess disposed centrally on a lower end thereof, such that the internally threaded recess is configured to receive an externally threaded protrusion disposed centrally on an upper side of the housing therein. In other embodiments, an upper side of the housing and a lower side of the base comprise a thermally conductive material. In yet another embodiment, the container comprises a thermally insulating material. In some embodiments, an indicator light is disposed on the housing, the indicator light configured to illuminate when the heating element is in the activated state. In another embodiment, a temperature control is disposed on the housing an operably connected to the heating element, wherein the temperature control is configured to adjust an output temperature of the heating element. In other embodiments, a disposed is disposed on the housing, wherein the display is configured to display a temperature set by the temperature control. In yet another embodiment, the container tapers radially from the open upper end towards the base, such that the open upper end comprises a diameter greater than that of the base. In some embodiments, the housing tapers radially from the upper side thereof towards a lower side thereof, such that the upper side comprises a diameter greater than that of the lower side, and wherein the housing and the container taper at identical angles. In another embodiment, a handle is disposed on the exterior surface of the container.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the heated beverage container system.

FIG. 2 shows an exploded cross-sectional view of an embodiment of the heated beverage container system.

FIG. 3A shows a front view of the housing of an embodiment of the heated beverage container system.

FIG. 3B shows a rear view of the housing of an embodiment of the heated beverage container system.

FIG. 4 shows a schematic view of an embodiment of the heated beverage container system.

### DETAILED DESCRIPTION OF THE INVENTION

Reference is made herein to the attached drawings. Like reference numerals are used throughout the drawings to depict like or similar elements of the heated beverage container system. The figures are intended for representative purposes only and should not be considered to be limiting in any respect.

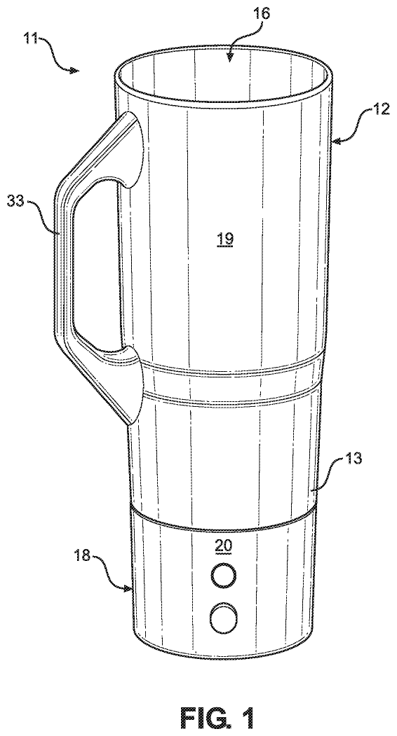

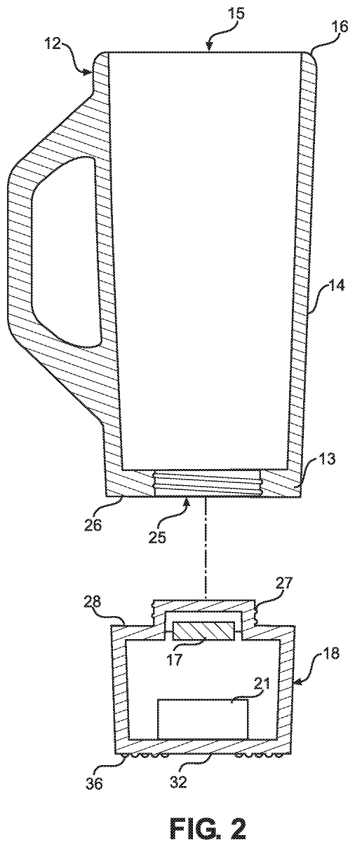

Referring now to FIG. 1, there is shown a perspective view of an embodiment of the heated beverage container system. The heated beverage container system 11 comprises a container 12 having a base 13 and an open upper end 16, wherein an annular sidewall 14 extends therebetween. The container 12 defines an interior volume (as shown in FIG. 2, 15) such that the container 12 can receive a beverage therein. In some embodiments, the container 12 comprises a thermally insulating material configured to minimize heat transfer therethrough, such that the beverage is maintained at a desired temperature for a prolonged period of time, while also preventing a user holding the container 12 from burning their hand. In some embodiments, the container 12 comprises a double walled vacuum configuration to act as heat insulation. Additionally, in alternate embodiments, the heated beverage container system 11 further comprises a lid removably securable within the open upper end 16, wherein the lid is configured to removably secure therein via friction fit. The lid is configured to form a watertight seal within the open upper end 16, such that tipping the container 12 does not cause a leak from the interior volume. In some embodiments, the lid further comprises an aperture along a perimeter thereof.

A housing 18 is removably securable to the base 13, wherein the housing 18 further comprises a heating element (as shown in FIG. 2, 17) therein. The removable nature of the housing 18 allows greater convenience to the user when cleaning the heated beverage container system 11, as the electronic components within the housing 18 can be separated from the container 12 during cleaning. The heating element is configured to transfer heat into the container 12, such that a beverage stored therein is heated and maintained at a desired temperature over a period of time. In the illustrated embodiment, an exterior surface 19 of the container 12 and an outer surface 20 of the housing 18 are continuous and aligned when the housing 18 is secured to the base 13. In this way, the container presents a streamlined form factor preventing the container 12 from catching on surrounding surfaces. In the illustrated embodiment, the container 12 further comprises a handle 33 thereon, wherein the handle 33 extends from the exterior surface 19. In some embodiments, the handle 33 comprises the same thermally insulating material as the container 12, while in alternate embodiments, the handle 33 is continuous with the exterior surface 19. The handle 33 is configured to provide a gripping surface for the user, allowing ease of transport of the heated beverage container system 11.

Referring now to FIG. 2, there is shown an exploded cross-sectional view of an embodiment of the heated beverage container system. The container 12 defines an interior volume 15, wherein the interior volume is configured to receive a beverage therein. In the illustrated embodiment, the container 12 further comprises an internally threaded recess 25 configured to receive a complementary externally threaded protrusion 27 therein, such that the housing 18 is removably securable to the base 13 of the container 12. In the illustrated embodiment, the internally threaded recess 25 and the externally threaded protrusion 27 are centrally disposed on a lower end 26 of the base 13 and an upper side 28 of the housing 18, respectively. In the illustrated embodiment, the upper side 28 is configured to abut the lower end 26 flush when the housing 18 is removably secured to the base 13, such that maximal surface area of the upper side 28 is in contact with the base 13. In this way, heat generated within the housing 18 is more readily transferred into the interior volume 15.

The heating element 17 is disposed within the housing 18 and is configured to transfer heat through the upper side 28 and the lower end 26 to the interior volume 15. In some embodiments, each of the upper side 28 and the lower end 26 comprise thermally conductive materials, such that thermal conductivity through the upper side 28 and the lower end 26 is greater than other portions of the container 12 and the housing 18. In this way, heat generated by the heating element 17 is more readily transferred into the interior volume 15. In the illustrated embodiment, the heating element 17 is operably connected to a first power source 21 disposed within the housing 18, wherein the first power source 21 is configured to provide power to the heating element 17 to generate heat therein. In some embodiments, the first power source 21 comprises a rechargeable battery, while in alternate embodiments, the first power source 21 comprises replaceable batteries removably securable within the housing 18.

In the illustrated embodiment, the container 12 tapers radially inwardly from the open upper end 16 towards the base 13, such that a diameter of the open upper end 16 is greater than that of the base 13. Similarly, in the shown embodiment, the housing 18 tapers radially inwardly from the upper side 28 thereof towards a lower side 32 thereof, such that the upper side 28 comprises a diameter greater than the lower side 32. In this way, the heated beverage container system 11 can be easily stored within various diameters of cup holder via friction fit. In some embodiments, the container 12 and the housing 18 taper at identical angles. Furthermore, in the illustrated embodiment, the lower side 32 further comprises a plurality of ridges 36 thereon, wherein the plurality of ridges 36 are configured to increase the surface area in contact with a support surface, thereby providing greater frictional engagement therewith. In some embodiments, the plurality of ridges 36 comprise a material having a coefficient of friction greater than one to further aid in frictional engagement with a support surface. In some embodiments, the plurality of ridges 36 comprise a series of concentric rings across the lower side 32.

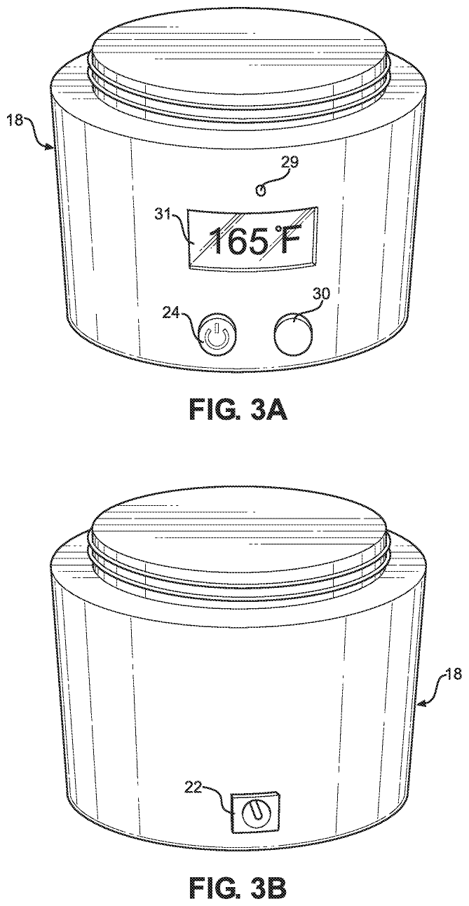

Referring now to FIGS. 3A and 3B, there is shown a front view of the housing of an embodiment of the heated beverage container system and a rear view of the housing of an embodiment of the heated beverage container system, respectively. In the illustrated embodiment of FIG. 3A, an activation control 24 is disposed on a front side of the housing 18, wherein the activation control 24 is configured to selectively toggle the heating element between an activated state and a deactivated state. In some embodiments, the activation control 24 comprises a push-button, however, alternate embodiments, such as switches and the like are also contemplated. In the illustrated embodiment of FIG. 3A, an indicator light 29 is disposed on the housing 18, wherein the indicator light 29 is configured to illuminate when the heating element is in the activated state, thereby informing the user that the heating element is actively heating the container.

Additionally, in the shown embodiment of FIG. 3A, a temperature control 30 is disposed on the housing 18, wherein the temperature control 30 is configured to adjust an output temperature of the heating element. As shown in FIG. 3A, the temperature control 30 comprises a dial, however, in alternate embodiments, other variable controls are contemplated, such as slider switches, potentiometers, and the like. In this way, the user can adjust the temperature of a beverage within the container to a desired temperature. In some embodiments, a display 31 is disposed on the front side of the housing 18, wherein the display is configured to display the temperature set by the user via the temperature control 30, such that the user can accurately heat the container to a desired temperature. In the illustrated embodiment, the display 31 comprises a digital display operably connected to the temperature control 30, however, in alternate embodiments, the display 31 is contemplated to comprise indicia about the temperature control 30 indicating the set temperature.

In the illustrated embodiment of FIG. 3B, the housing 18 further comprises an outlet 22 thereon, wherein the outlet 22 is configured to operably connect the heating element to an external secondary power source, such as a wall outlet, generator, or the like. In the illustrated embodiment, the outlet 22 is shown as a port for an AC converter, however, alternate power transfer ports are also contemplated. In the illustrated embodiment, the outlet 22 is disposed opposite the activation control 24, such that when the outlet 22 is connected to the second power source, any cords, cables, wires, or the like are hidden from view by the housing 18. In this way, when a user is relying on the second power source, the heated beverage container system is unobtrusive.

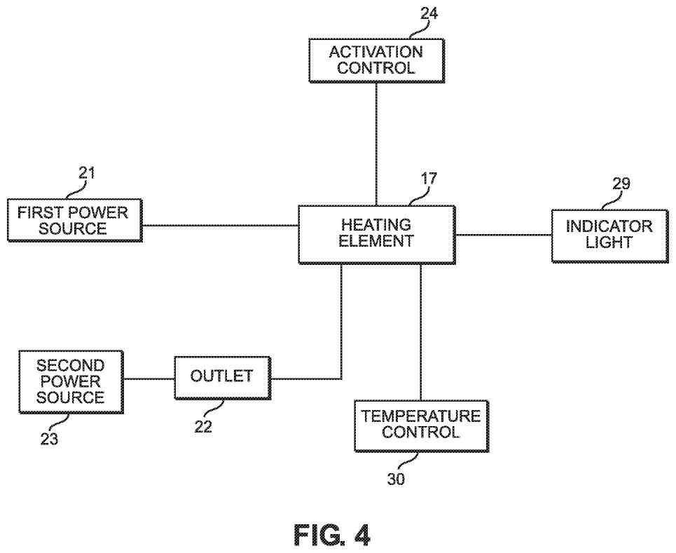

Referring now to FIG. 4, there is shown a schematic view of an embodiment of the heated beverage container system. In the illustrated embodiment, the heating element 17 is operably connected to each of the activation control 24, temperature control 30, and the indicator light 29, such that the heating element 17 is configured to activate and output a desired temperature when the controls, 24, 30 are actuated and the indicator light is configured to illuminate when the heating element 17 is in the activated state. The first power source 21 is directly operably connected to the heating element 17, whereas the second power source 23 is operably connected to the heating element 17 via the outlet 22. Furthermore, in the illustrated embodiment, the first power source 21 is independent from the second power source 23, such that the heated beverage container system can draw power from each of the first and second power sources 21, 23. In some embodiments, the second power source 23 is given priority over the first power source 21, such that the heating element 17 draws power from the second power source 23 before the first power source 21. In this way, the first power source 21 is only providing power when the heated beverage container system is in a portable state disconnected from the second power source 23, thereby reducing the frequency of required recharging or replacing of the first power source 21.

In one exemplary use, the user fills the interior volume of the container with a desired beverage and removably secures the housing to the base of the container. Once the activation control 24 is actuated, the heating element 17 within the housing activates transferring heat through the housing and into the interior volume, heating the beverage therein. In some embodiments, the user can adjust the temperature output by the heating element 17 via the temperature control 30 to produce a desired temperature. A user can connect the second power source 23 to the heating element 17 via the outlet 22, such as when initially heating the beverage before leaving a home or office. When disconnected from the second power source 23, the first power source 21 provides power to the heating element 17, ensuring that the beverage is maintained at the desired temperature throughout the day. In some embodiments, the user can then place the container and housing system within a cupholder, allowing the tapering of the container and the housing to frictionally engage the system with a variety of cupholder sizes. Finally, once the beverage has been consumed, the user can actuate the activation control 24 to deactivate the heating element 17.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A heated beverage container system, comprising:
a container comprising a base having an annular sidewall extending therefrom defining an interior volume;
wherein the annular sidewall terminates at an open upper end;
a heating element disposed within the housing;
wherein the housing is configured to removably secure to the base such that heat generated by the heating element is transferred into the interior volume;
a first power source disposed within the housing and operably connected to the heating element;
an outlet disposed on the housing, wherein the outlet is configured to operably connect the heating element to a second power source;
wherein the first power source and the second power source are independent;
an activation control disposed on the housing, wherein the activation control selectively toggles the heating element between an activated state and a deactivated state.

2. The heated beverage container system of claim 1, wherein the base comprises an internally threaded recess disposed centrally on a lower end thereof, such that the internally threaded recess is configured to receive an externally threaded protrusions disposed centrally on an upper side of the housing therein.

3. The heated beverage container system of claim 1, wherein an upper side of the housing and a lower side of the base comprise a thermally conductive material.

4. The heated beverage container system of claim 1, wherein the container comprises a thermally insulating material.

5. The heated beverage container system of claim 1, further comprising an indicator light disposed on the housing, the indicator light configured to illuminate when the heating element is in the activated state.

6. The heated beverage container system of claim 1, further comprising a temperature control disposed on the housing and operably connected to the heating element, wherein the temperature control is configured to adjust an output temperature of the heating element.

7. The heated beverage container system of claim 6, further comprising a display disposed on the housing, wherein the display is configured to display a temperature set by the temperature control.

8. The heated beverage container system of claim 1, wherein the container tapers radially from the open upper end towards the base, such that the open upper end comprises a diameter greater than that of the base.

9. The heated beverage container system of claim 8, wherein the housing tapers radially from the upper side thereof towards a lower side thereof, such that the upper side comprises a diameter greater than that of the lower side, wherein the housing and the container taper at identical angles.

10. The heated beverage container system of claim 1, further comprising a handle disposed on an exterior surface of the container.

11. A heated beverage container system, comprising:
a container comprising a base having an annular sidewall extending therefrom defining an interior volume;
wherein the annular sidewall terminates at an open upper end;
a heating element disposed within the housing;
wherein the housing is configured to removably secure to the base such that heat generated by the heating element is transferred into the interior volume;
wherein an exterior surface of the container and an outer surface of the housing are aligned when the housing is secured to the base;
a first power source disposed within the housing and operably connected to the heating element;
an outlet disposed on the housing, wherein the outlet is configured to operably connect the heating element to a second power source;
wherein the first power source and the second power source are independent;
an activation control disposed on the housing, wherein the activation control selectively toggles the heating element between an activated state and a deactivated state.

12. The heated beverage container system of claim 11, wherein the base comprises an internally threaded recess disposed centrally on a lower end thereof, such that the internally threaded recess is configured to receive an externally threaded protrusions disposed centrally on an upper side of the housing therein.

13. The heated beverage container system of claim 11, wherein an upper side of the housing and a lower side of the base comprise a thermally conductive material.

14. The heated beverage container system of claim 11, wherein the container comprises a thermally insulating material.

15. The heated beverage container system of claim 11, further comprising an indicator light disposed on the housing, the indicator light configured to illuminate when the heating element is in the activated state.

16. The heated beverage container system of claim 11, further comprising a temperature control disposed on the housing and operably connected to the heating element, wherein the temperature control is configured to adjust an output temperature of the heating element.

17. The heated beverage container system of claim 16, further comprising a display disposed on the housing, wherein the display is configured to display a temperature set by the temperature control.

18. The heated beverage container system of claim 11, wherein the container tapers radially from the open upper end towards the base, such that the open upper end comprises a diameter greater than that of the base.

19. The heated beverage container system of claim 18, wherein the housing tapers radially from the upper side thereof towards a lower side thereof, such that the upper side comprises a diameter greater than that of the lower side, wherein the housing and the container taper at identical angles.

20. The heated beverage container system of claim 11, further comprising a handle disposed on the exterior surface of the container.
